(19) United States
(12) Patent Application Publication
(10) Pub. No.: US 2015/0150078 A1
(43) Pub. Date: May 28, 2015

(54) APPARATUS AND METHOD FOR ENHANCING COMPUTER SYSTEM SECURITY

(71) Applicant: POSTECH ACADEMY-INDUSTRY FOUNDATION, Gyeongsangbuk-do (KR)

(72) Inventors: Chanik PARK, Gyeongsangbuk-do (KR); Woo Ram PARK, Gyeongsangbuk-do (KR); Jae Bok SHIN, Gyeongsangbuk-do (KR)

(21) Appl. No.: 14/554,340

(22) Filed: Nov. 26, 2014

(30) Foreign Application Priority Data
Nov. 27, 2013 (KR) 10-2013-0145638

(51) Int. Cl. H04L 29/06

(52) U.S. Cl. CPC H04L 63/20
USPC 726/1

(57) ABSTRACT

Provided are an apparatus and method for enhancing computer system security by applying a security polity to mobile user equipment. The apparatus includes a security policy monitor unit for switching a job environment of a user equipment to a secure job environment corresponding to a security policy so as to apply the security policy to the user equipment loaded into a system to which the security policy is applied; and a secure job environment providing unit for providing an execution environment based on the secure job environment via the user equipment. Accordingly, the security policy may be guaranteed to be continuously and securely applied while a job is performed in the system.

### CLAIM FOR PRIORITY

This application claims priority to Korean Patent Application No. 10-2013-0145638 filed on Nov. 27, 2013 in the Korean Intellectual Property Office (KIPO), the entire contents of which are hereby incorporated by reference.

### BACKGROUND

1. Technical Field

Example embodiments of the present invention relate to a technique of enhancing the security for a computer system, and more particularly, to an apparatus and method for enhancing the security for a computer system by applying a security policy to mobile user equipment.

2. Related Art

Security is a very important issue in information technology (IT) environments of systems. As many companies have increasingly suffered from leakage of core technology or confidential documents, financial damages caused to the companies have been increased.

As advances in mobile computing technology have led to an increase in the availability of mobile devices in a work environment, various job processes can be performed using mobile devices but security data is likely to be leaked by releasing work data to the outside via mobile devices. To prevent this problem, a predefined computer system security policy (which should be understood as covering various security solution programs, e.g., a document management program such as digital rights management (DRM), a mobile storage control program, etc. according to the present invention) is prescribed to be applied to all user computer systems, but a computer system environment to which the security policy is applicable is limited.

Thus, there is a need to develop a method of consistently applying a security policy to user computer systems loaded into a system.

In general, virtual desktop infrastructure (VDI) technology has been introduced to consistently apply a security policy to job environments of all computer systems loaded into a system and control job data stored in data recording apparatuses of the computer systems. The VDI technology is largely classified into server-based VDI technology and client-based VDI technology. However, neither the server-based VDI technology nor the client-based VDI technology provides a perfect security solution due to their limitations.

FIGS. 1 and 2 are conceptual diagrams illustrating the structures of VDI technology-based information technology (IT) environments of a system according to the related art.

As illustrated in FIG. 1, a server-based VDI technology 10 is advantageous in that images of job environments of all clients (user computer systems) 11 and job data are respectively stored in a job environment image storage place and a job data storage place and are managed centrally, and that the server-based VDI technology 10 is hardly subject to a client environment.

However, additional server installation costs are high since a VDI service should be individually provided to a plurality of users, and network maintenance and repair costs are high since network dependency is high to cause excessive network use. Also, it is difficult to control various input/output functions that can be operated in clients, thereby guaranteeing security.

As illustrated in FIG. 2, when a client-based VDI technology 20 is employed, server installation costs are lower than when the server-based VDI technology 10 is employed, and the performances of clients 21 can be utilized.

However, since an infrastructure environment should be established beforehand to apply the client-based VDT technology 20 to the clients 21, available client environments are limited. Also, job data stored in the clients 21 is difficult to manage centrally and is thus likely to be leaked to the outside.

### SUMMARY

Accordingly, example embodiments of the present invention are provided to substantially obviate one or more problems due to limitations and disadvantages of the related art.

Example embodiments of the present invention provide a method of effectively applying a system security policy to user equipment loaded into a system.

Example embodiments of the present invention provide an apparatus for effectively applying a system security policy to user equipment loaded into a system.

In some example embodiments, an apparatus for enhancing computer system security includes a security policy monitor unit configured to switch a job environment of a user equipment to a secure job environment corresponding to a security policy so as to apply the security policy to the user equipment loaded into a system to which the security policy is applied; and a secure job environment providing unit configured to provide an execution environment based on the secure job environment via the user equipment.

The security policy monitor unit may be executed in a region different from a region in which the user equipment is installed, and have a highest execution authorization with respect to the user equipment.

The security policy monitor unit may include an environment change/restoration module configured to switch the job environment of the user equipment to the secure job environment or restore the job environment, according to whether the user equipment is loaded into the system to which the security policy is applied.

The security policy monitor unit may include a verification information collection module configured to collect verification information and authenticate the verification information through an authentication management server operated in the system to which the security policy is applied, wherein the verification information may include at least one of integrity information regarding the security policy monitor unit; integrity information regarding the security policy; and information regarding a data encrypting and storing space.

The security policy monitor unit may further include a data protection key management module configured to receive and manage a data protection key allocated to the user equipment for which the authentication of the verification information is completed. The data protection key may be used to limit use of data generated in the execution environment based on the secure job environment when the user equipment is unloaded to the outside from the system to which the security policy is applied.

The security policy monitor unit may include a security policy application module configured to receive and manage the security policy including information regarding network access control and data storage.

The security policy monitor unit may further include a storage unit management module configured to manage the data, which is generated in the execution environment based on the secure job environment, according to the security policy.

The apparatus may further include a storage unit which is configured to store the data generated in the execution environment based on the secure job environment and is managed by the storage unit management module.

In some example embodiments, a method of enhancing computer system security includes switching a job environment of a user equipment to a secure job environment corresponding to a security policy when the user equipment is loaded into a system to which the security policy is applied; and providing an execution environment based on the secure job environment via the user equipment.

### BRIEF DESCRIPTION OF DRAWINGS

Example embodiments of the present invention will become more apparent by describing in detail example embodiments of the present invention with reference to the accompanying drawings, in which:

FIGS. 1 and 2 are conceptual diagrams illustrating the structures of virtual desktop infrastructure (VDI) technology-based information technology (IT) environments of a system according to the related art;

FIG. 3 is a conceptual diagram illustrating an apparatus and method for enhancing computer system security according to an embodiment of the present invention;

FIG. 4 is a block diagram of an apparatus for enhancing computer system security according to an embodiment of the present invention; and

FIG. 5 is a flowchart of a method of enhancing computer system security according to an embodiment of the present invention.

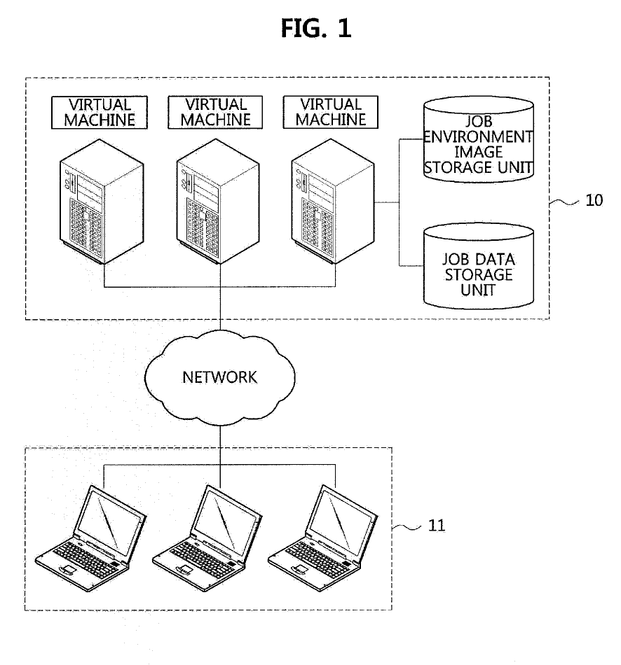

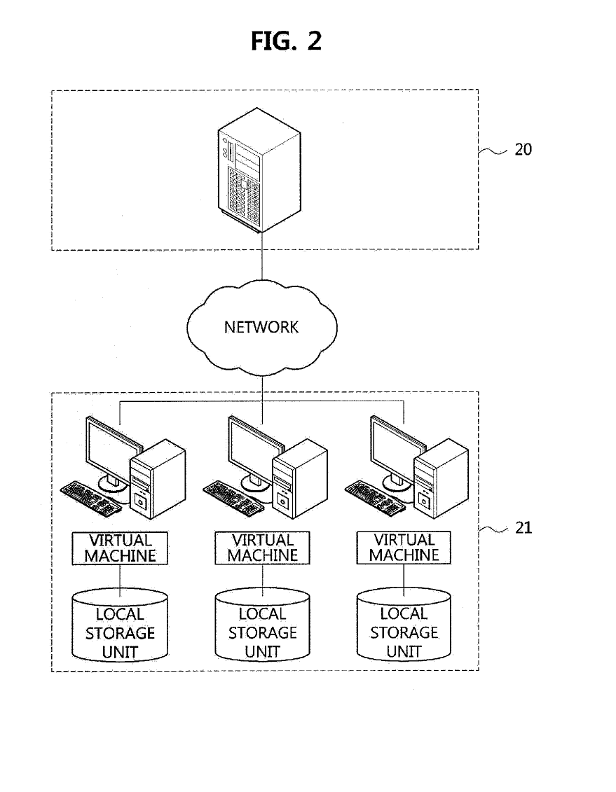

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

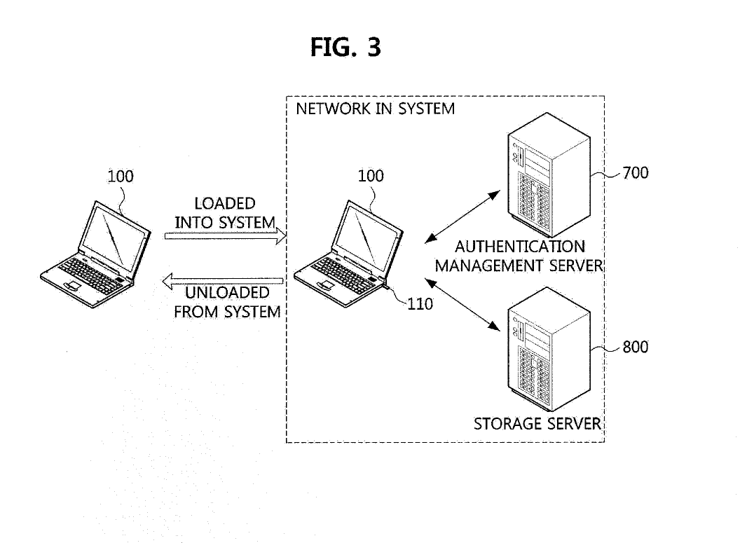

FIG. 3 is a conceptual diagram illustrating an apparatus and method for enhancing computer system security according to an embodiment of the present invention.

Referring to FIG. 3, when user equipment 100 is loaded into a system, a security policy monitor may be applied to the user equipment 100.

First, in the present disclosure, the term “user equipment (UE)” may be interchangeably used with a mobile station, a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Examples of the user equipment 100 may include, but are not limited to, a cellular phone, a smartphone with a wireless communication function, a personal digital assistant (PDA) with a wireless communication function, a wireless modem, a portable computer with a wireless communication function, a photographing apparatus with a wireless communication function (such as a digital camera), a gaming device with a wireless communication function, am electronic music storing and reproducing appliance with a wireless communication function, an Internet-based home appliance with a wireless Internet access and browsing function, and other portable units or terminals with a combination of the above functions.

Here, the term ‘system’ should be understood as a company or a public organization to which a security policy may be established and applied. That is, when the user equipment 100 is loaded into a system to which the security policy is applied, the security policy established by and applied to the system requires to be also applied to the user equipment 100.

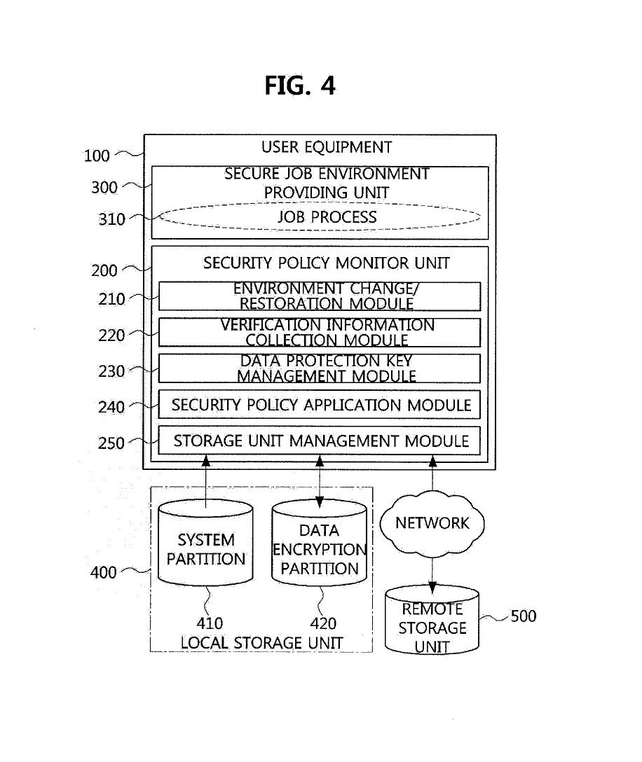

To securely apply the security policy to the user equipment 100, a highest execution authorization should be allocated to a program or system for applying the security policy (hereinafter referred to as a ‘security policy monitor unit’). Also, a security policy monitor unit 200 of FIG. 4 needs to be executed in a region different from a region in which the user equipment 100 is installed.

When the user equipment 100 is loaded into the system, the security policy monitor unit 200 may be applied to the user equipment 100. For example, when the user equipment 100 is loaded into the system, the security policy monitor unit 200 may be applied to the user equipment 100 via a security policy monitor unit application medium 110 so as to switch a job environment of the user equipment 100 to a secure job environment. Here, the security policy monitor unit application medium 110 may include a hardware-based virtualization and security technique, a network booting technique, a portable storage device (a USB storage device or a mobile disk), or the like, but embodiments of the present invention are not limited thereto. That is, the security policy monitor unit 200 may be executed in a region different from where the user equipment 100 is installed and have the highest execution authorization with respect to the user equipment 100.

Also, the user equipment 100 to which the security policy monitor unit 200 is applied may be interlinked with an authentication management server 700 or a storage server 800 (or a remote storage unit 500) operated or managed in the system. For example, the security policy monitor unit 200 may authenticate, through the authentication management server 700, verification information including at least one among integrity information regarding the security policy monitor unit 200, integrity information regarding the security policy, and information regarding a data encrypting and storing space. Also, the security policy monitor unit 200 may store data, which is generated in an execution environment based on the secure job environment, in the storage server 800.

FIG. 4 is a block diagram of an apparatus for enhancing computer system security according to an embodiment of the present invention.

Referring to FIG. 4, the apparatus for enhancing computer system security is applicable to the user equipment 100. That is, the security policy monitor unit 200 may be applied to the user equipment 100, and a secure job environment providing unit 300 may provide an execution environment based on a secure job environment according to the security policy monitor unit 200. Although for convenience of explanation, the security policy monitor unit 200 is illustrated in the user equipment 100 in FIG. 4, the security policy monitor unit 200 may be executed in a region different from the region in which the user equipment 100 is installed.

That is, the security policy monitor unit 200 may switch a job environment of the user equipment 100 to the secure job environment corresponding to the security policy so as to apply the security policy to the user equipment 100 loaded in a system to which the security policy is applied.

Also, the secure job environment providing unit 300 may provide the execution environment based on the secure job environment through the user equipment 100.

The security policy monitor unit 200 may store or manage data generated in the execution environment based on the secure job environment while being interlinked with a local storage unit 400 or a remote storage unit 500.

In detail, the security policy monitor unit 200 according to an embodiment of the present invention may include an environment change/restoration module 210, a verification information collection module 220, a data protection key management module 230, a security policy application module 240, and a storage unit management module 250.

The environment change/restoration module 210 may switch the job environment of the user equipment 100 to the secure job environment or restore the job environment according to whether the user equipment 100 is loaded into a system to which the security policy is applied.

The verification information collection module 220 may collect verification information including at least one among integrity information regarding the security policy monitor unit 200, integrity information regarding the security policy, and information regarding a data encrypting and storing space, and authenticate the verification information through the authentication management server 700 operated in the system to which the security policy is applied.

The data protection key management module 230 may receive and manage a data protection key allocated to the user equipment 100 for which the authentication of the verification information is completed. Here, the data protection key may be understood as key information for encrypting data generated in the execution environment based on the secure job environment to limit the use of the data when the user equipment 100 is unloaded from the system to which the security policy is applied.

The security policy application module 240 may receive and manage the security policy including information regarding network access control and data storage.

The storage unit management module 250 may manage the data, which is generated in the execution environment based on the secure job environment, according to the security policy.

The apparatus for enhancing computer system security may further include a storage unit that is configured to store the data generated in the execution environment based on the secure job environment and that is managed by the storage unit management module 250. Here, the storage unit may be classified into the local storage unit 400 and the remote storage unit 500. The local storage unit 400 may be divided into a system partition 410 and a data encryption partition 420. The remote storage unit 500 may be configured through the storage server 800 included in the system.

Although some components of the apparatus for enhancing computer system security according to an embodiment of the present invention have been described herein for convenience of explanation, at least two among these components may be integrally formed as one component or at least one component among these components may be divided into several components according to other embodiments of the present invention without departing from the scope and spirit of the present invention.

Also, the apparatus for enhancing computer system security according to an embodiment of the present invention can be embodied as a computer-readable program or code recorded on a non-transitory computer-readable recording medium. The non-transitory computer-readable recording medium may be any recording apparatus capable of storing data that can be read by a computer system. The non-transitory computer-readable medium can be distributed among computer systems that are interconnected through a network, and the present invention may be stored and implemented as a computer-readable program or code in the distributed system.

Operations that may be performed by the apparatus for enhancing computer system security according to an embodiment of the present invention will be described in detail below.

According to the present invention, the security policy monitor unit 200 allocated the highest execution authorization and operating in an independent execution environment may be applied to the user equipment 100 so as to provide a secure job environment operated in an execution environment allocated a lower execution authorization than that of the security policy monitor unit 200.

Here, the independent execution environment may be configured to support hardware virtualization technology such as Intel VT-d, and hardware-based security technology such as Intel Trusted eXecution Technology (TXT), AMD Secure Virtual Machine (SVM), ARM TrustZone, and System Management Mode (SMM).

The security policy monitor unit 200 has the highest execution authorization over the user equipment 100 loaded into the system, and may thus protect the user equipment 100 from being accessed by unauthorized(OK?) users through the secure job environment and guarantee the security policy to be securely and continuously applied.

Here, the secure job environment may provide a job process 310, such as a word processing program, a source code creating and developing program, etc., to facilitate a user's work.

Also, the secure job environment may be configured in such a manner that a user job environment that has already been installed before the user equipment 100 is loaded into a system is operated in an execution environment allocated a lower execution authorization than that of the security policy monitor unit 200. In the secure job environment, a user may perform the job process 310 similarly to in an environment to which the security policy monitor unit 200 is not applied.

In the independent execution environment having the highest execution authorization of the user equipment 100, a job environment may be switched to another environment or restored using the security policy monitor unit 200. For example, when the user equipment 100 is unloaded from the system after a job is ended, a job of restoring a previous user job environment may be performed.

The storage unit management module 250 may separately store data generated and encrypted in an execution environment based on the secure job environment. Here, the encrypted data may be controlled to not be accessed in environments to which the security policy monitor unit 200 is not applied.

For example, the storage unit management module 250 may drive the secure job environment by loading an existing user environment image stored in the system partition 410 of the local storage unit 400 of the user equipment 100 loaded in the system. Also, resultant data generated when a user job is performed may be stored in the remote storage unit 500, which is operated by the system, via a network.

The security policy application module 240 may manage a system security policy related to network access control and 1/0 access control of the local storage unit 400 and the remote storage unit 500. For example, the security policy may be applied in units of user equipments 100 to be loaded in the system or in units of users, based on a policy determined by the system.

A data protection key needs to be provided in units of user equipment 100 so as to record data on or access data recorded on a storage unit. To this end, the authentication management server 700 may create a data protection key and provide it to the user equipment 100 to be loaded in the system.

The data protection key management module 230 may securely store and manage the data protection key in the user equipment 100 loaded in the system.

The verification information collection module 220 may collect and manage verification information including at least one among integrity information regarding components of the security policy monitor unit 200, integrity information regarding a network and storage security policy, and ordinary configuration information regarding a data encrypting and storing space.

The collected verification information may be verified through a verification process performed by the authentication management server 700, and the authentication management server 700 may provide a data protection key to the user equipment 100 based on a result of verifying the verification information. Here, the verification information may be stored in a secure memory space that is accessible only by the security policy monitor unit 200 or may be stored securely by hardware.

Although some components of an apparatus for enhancing computer system security according to an embodiment of the present invention have been described herein for convenience of explanation, at least two among these components may be integrally formed as one component or at least one component among these components may be divided into several components according to other embodiments of the present invention without departing from the scope and spirit of the present invention.

Also, the apparatus for enhancing computer system security according to an embodiment of the present invention can be embodied as a computer-readable program or code recorded on a non-transitory computer-readable recording medium. The non-transitory computer-readable recording medium may be any recording apparatus capable of storing data that can be read by a computer system. The non-transitory computer-readable medium can be distributed among computer systems that are interconnected through a network, and the present invention may be stored and implemented as a computer-readable program or code in the distributed system.

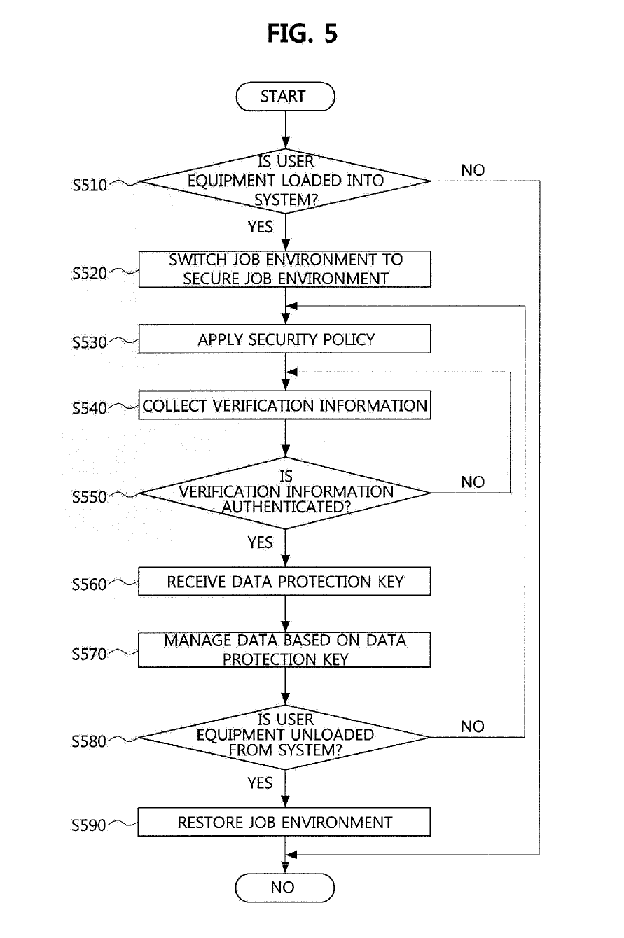

FIG. 5 is a flowchart of a method of enhancing computer system security according to an embodiment of the present invention.

In the method of enhancing computer system security according to an embodiment of the present invention, when the user equipment 100 of FIG. 3 is loaded into a system to which a system policy is applied, a job environment of the user equipment 100 may be switched to a secure job environment corresponding to the security policy and an execution environment based on the secure job environment may be provided using the user equipment 100.

Referring to FIG. 5, whether the user equipment 100 is loaded into the system may be determined by a user (operation S510). Next, when it is determined that the user equipment 100 is loaded into the system, the job environment of the user equipment 100 may be switched to the secure job environment by applying the security policy monitor unit 200 to the user equipment 100 by operating the security policy monitor unit application medium 110 with respect to the user equipment 100 (operation S520).

Next, a security policy including information regarding network access control and data storage may be received and applied to the secure job environment (operation S530).

Next, verification information including at least one of integrity information regarding the security policy and information regarding data encrypting and storing space may be collected (operation S540), and may be then authenticated using the authentication management server 700 operating in the system to which the security policy is applied (operation S550).

When the authentication of the verification information is completed, a data protection key allocated to the user equipment 100 may be received (operation S560).

Then, data may be managed based on the data protection key (operation S570). That is, the data protection key may be applied to data generated in an execution environment based on the secure job environment. Here, the data protection key may be used to limit use of the data generated in the execution environment based on the secure job environment when the user equipment 100 is unloaded from the system to which the security policy is applied.

Since the data generated in the execution environment based on the secure job environment is encrypted using the data protection key, the data may be prevented from being decrypted outside the system to check the content of the data.

When the authentication of the verification information is unsuccessful, verification information may be collected again.

Next, whether the user equipment 100 is unloaded from the system to which the security policy is applied may be determined (operation S580). When it is determined that the user equipment 100 is unloaded from the system, the job environment of the user equipment 100 may be restored (operation S590).

The method of enhancing computer system security according to an embodiment of the present invention may be performed by the apparatus for enhancing computer system security of FIG. 4 and thus may be made more apparent from the above description regarding the apparatus for enhancing computer system security of FIG. 4.

In an apparatus and method for enhancing computer system security according to an embodiment of the present invention, the security policy monitor unit 200 for applying a security policy of a system to the user equipment 100 is executed in an independent execution environment that is not accessible by unauthorized users. Thus, the security policy may be prevented from being arbitrarily changed by unauthorized users, thereby guaranteeing the security policy to be securely and continuously applied while a job is performed in the system.

Also, since a function of switching a job environment of the user equipment 100 to a secure job environment or restoring the job environment is supported, the job environment of the user equipment 100 need not be completely changed to apply the security policy to the user equipment 100.

Also, a data protection key may be applied to data generated while the user equipment 100 is switched to the secure job environment so as to protect the data from being accessed by unauthorized users when the user equipment 100 is unloaded from the system to the outside, thereby preventing a core technology of the system from being leaked.

Furthermore, the security policy monitor unit 200 may support the user equipment 100 that is available for various environments to flexibly expand an IT environment of the system, and the performance of the user equipment 100 may be best utilized to greatly reduce server installation costs and save network maintenance costs.

In an apparatus and method for enhancing computer system security according to an embodiment of the present invention, a security policy monitor unit is executed in an independent execution environment that is not accessible by unauthorized users. Thus, a security policy may be prevented from being arbitrarily changed by unauthorized users, thereby guaranteeing the security policy to be securely and continuously applied while a job is performed in a system.

Also, a data protection key may be applied to data generated while a user equipment is switched to a secure job environment so as to protect the data from being accessed by unauthorized users when the user equipment is unloaded from the system to the outside, thereby preventing a core technology of the system from being leaked.

Also, since a function of switching a job environment of the user equipment to a secure job environment or restoring the job environment is supported, a job environment of the user equipment need not be completely changed to apply the security policy to the user equipment.

While the example embodiments of the present invention and their advantages have been described in detail, it should be understood that various changes, substitutions and alterations may be made herein without departing from the scope of the invention.

What is claimed is:

1. An apparatus for enhancing computer system security, the apparatus comprising:
a security policy monitor unit configured to switch a job environment of user equipment to a secure job environment corresponding to a security policy so as to apply the security policy to the user equipment loaded into a system to which the security policy is applied; and
a secure job environment providing unit configured to provide an execution environment based on the secure job environment via the user equipment.

2. The apparatus of claim 1, wherein the security policy monitor unit executes in a region different from a region in which the user equipment is installed, and has a highest execution authorization with respect to the user equipment.

3. The apparatus of claim 1, wherein the security policy monitor unit comprises an environment change/restoration module configured to switch the job environment of the user equipment to the secure job environment or restore the job environment, according to whether the user equipment is loaded into the system to which the security policy is applied.

4. The apparatus of claim 1, wherein the security policy monitor unit comprises a verification information collection module configured to collect verification information and authenticate the verification information through an authentication management server operated in the system to which the security policy is applied,
wherein the verification information comprises at least one of:
integrity information regarding the security policy monitor unit;
integrity information regarding the security policy; and
information regarding a data encrypting and storing space.

5. The apparatus of claim 4, wherein the security policy monitor unit further comprises a data protection key management module configured to receive and manage a data protection key allocated to the user equipment for which the authentication of the verification information is completed.

6. The apparatus of claim 5, wherein the data protection key is used to limit use of data generated in the execution environment based on the secure job environment when the user equipment is unloaded to the outside from the system to which the security policy is applied.

7. The apparatus of claim 1, wherein the security policy monitor unit comprises a security policy application module configured to receive and manage the security policy including information regarding network access control and data storing.

8. The apparatus of claim 7, wherein the security policy monitor unit further comprises a storage unit management module configured to manage the data, which is generated in the execution environment based on the secure job environment, according to the security policy.

9. The apparatus of claim 8. further comprising a storage unit which is configured to store the data generated in the execution environment based on the secure job environment and is managed by the storage unit management module.

10. A method of enhancing computer system security, the method of comprising:
switching a job environment of a user equipment to a secure job environment corresponding to a security policy when the user equipment is loaded into a system to which the security policy is applied; and
providing an execution environment based on the secure job environment via the user equipment.

11. The method of claim 10, further comprising receiving the security policy including information regarding network access control and data storage, and applying the security policy to the secure job environment.

12. The method of claim 10, further comprising collecting verification information and authenticating the verification information through an authentication management server operating in the system to which the security policy is applied,
wherein the verification information comprises at least one of:
integrity information regarding the security policy; and
information regarding a data encrypting and storing space.

13. The method of claim 12, further comprising receiving and managing a data protection key allocated to the user equipment for which the authentication of the verification information is completed.

14. The method of claim 13, wherein the receiving and managing of the data protection key comprises applying the data protection key to data generated in the execution environment based on the secure job environment.

15. The method of claim 14, wherein the data protection key is used to limit use of the data generated in the execution environment based on the secure job environment when the user equipment is unloaded to the outside from the system to which the security policy is applied.

16. The method of claim 10, wherein the job environment of the user equipment is restored when the user equipment is unloaded to the outside from the system to which the security policy is applied.
